(19) United States
(12) Patent Application Publication
(10) Pub. No.: US 2011/0060648 A1
(43) Pub. Date: Mar. 10, 2011

(54) Computer implemented method for marketing business services

(76) Inventors: Troy David Weaver, Lehighton, PA (US); Troy Gates, Sun Prairie, WI (US)

(21) Appl. No.: 11/546,953

(22) Filed: Oct. 12, 2006

Related U.S. Application Data
(60) Provisional application No. 60/732,278, filed on Oct. 31, 2005.

(51) Int. Cl. G06Q 30/00

(52) U.S. Cl. 705/14.49

(57) ABSTRACT

This invention is directed to a computer implemented method for marketing business services. The invention more particularly relates to a computer implemented method for generating a document to market business services.

### CROSS-REFERENCE TO RELATED APPLICATION

This application claims priority under 35 U.S.C. §119 from U.S. Provisional Application Ser. No. 60/732,278, filed Oct. 31, 2005.

### FIELD OF THE INVENTION

This invention is directed to a computer implemented method for marketing business services. The invention more particularly relates to a computer implemented method to generate a marketing document to market business services.

### BACKGROUND OF THE INVENTION

It is common to have a financial responsibility policy such as an insurance or a warranty policy to cover entire or a part of costs for repairing, replacing or maintenance of an article, such as an automotive vehicle, a house, furniture, or a durable electronics, within a certain period of time under certain conditions set forth by the financial responsibility policy. There are typically multiple parties involved: a customer who owns the article covered by the financial responsibility policy, an agency who issues the financial responsibility policy or is a representative of the issuer of the policy, and a service provider who provides a service operation on the article for the customer and receives a payment from the agency to cover entire or a part of the costs of the service operation wherein the service operation can be for repairing, replacing or maintenance of the article. Policies on automotive vehicle insurance, residential or commercial house insurance, consumer electronics insurance and warranty are a few examples of such financial responsibility policies. There can be additional parties involved, such as a third party who causes a damage to the article of the customer, and a second insurance agency who is an issuer or a representative of the issuer of a second insurance policy held by the third party when at least a portion of the cost of repairing the damaged article of the customer is covered by the second insurance policy. Since the customer has choices to select from a number of agencies who issue the financial responsibility policy and to choose from a number of service providers to service the article, it is critical for the agency of the financial responsibility and the service providers to market their services to the customer. Traditionally, the agencies and the service providers can use general marketing methods, such as public advertisement display, marketing letters, newspaper advertisements (ads), telephone directory listing, television or radio ads, to market their services. These general marketing methods, however, are often afflicted with low efficiency. Marketing materials received by recipients from these general marketing methods are often discarded or misplaced by the recipients.

In automotive vehicle insurance and repair industry, a typical vehicle repair begins with the customer contacting the insurance agency to report and file a claim on a damaged vehicle covered by the insurance policy. The insurance policy can be held by the customer or a third party who is responsible for the repair of the vehicle, the latter is often the case when the vehicle of the customer is damaged by the third party. The insurance agency examines the policy coverage qualification and refers the customer to a vehicle repair service, such as a vehicle body shop to obtain a repair estimate. If an agreement is reached among the customer, the insurance agency and the body shop, the damaged vehicle is repaired at the body shop. The customer can choose a different body shop on his preference, past experience with the body shop, a referral, or some other factors. The insurance agency can also refer the customer to different body shop based on a number of factors, such as the agency's preference, past experience, agency's evaluation of the body shop expertise, and quality of services. To stay in business, a vehicle body shop needs to market its services to the agency and to the current customers and to attract new customers. Similarly, the insurance agency markets its service by demonstrating its quality of service to the customer in order to retain the customer and to attract more future customers. If the agency referred the customer to a body shop that resulted in un-satisfactory experience of the customer, it is likely that the customer can choose another insurance agency when renewing the insurance policy. Currently, the insurance agency can market its service to customers through traditional methods, such as ads, general marketing letters, handouts, marketing fliers, telephone directory listing, and signage. The body shop can use similar methods to market its services to the customers. These traditional marketing methods have low efficiency. The body shop, in particular, lacks an effective method to market its service to the insurance agency. Marketing materials from these general marketing methods are often discarded or misplaced by the customer or the insurance agency. A need therefore exists for a method to effectively market the aforementioned business services, particularly for a method for generating a marketing document that relates to the vehicle of the customer, the insurance services provided by the insurance agency and the vehicle repair services provided by the body shop.

Similar situations exist for other insurance services, such as house insurances, aircraft insurances, water vessel insurances, home appliance insurances, electronic equipment insurances and warranty services and other financial responsibility services that cover certain costs of repairing, replacing or maintaining an article of a customer.

### SUMMARY OF THE INVENTION

This invention is directed to a computer implemented marketing method comprising the steps of:
a) entering a first information set comprising customer information and service provider information of one or more service providers into a computing device (1), said service provider having proficiency to perform a service operation on an article of the customer;
b) entering service data related to performing said service operation on the article into the computing device (1);
c) selecting a template from a second database (14) residing in storage media (3) of the computing device (1) based on the first information set and the service data;
d) generating a marketing document in the computing device (1) by integrating a receiving address of at least one recipient of the marketing document and a content from the first information set, the service data and a marketing message into the template; and
e) delivering the marketing document to the receiving address of said recipient.

This invention is also directed to a computer implemented marketing method comprising the steps of:
a) entering a first information set comprising customer information and service provider information of one or more service providers into a computing device (1), said service provider having proficiency to perform a service operation on an article of the customer;
b) entering service data related to performing said service operation on the article into the computing device (1); c) retrieving a second information set from a first database (16) residing in the storage media (3) of the computing device (1) based on the first information set;
d) selecting a template from a second database (14) residing in storage media (3) of the computing device (1) based on the first information set and the service data;
e) generating a marketing document in the computing device (1) by integrating a receiving address of at least one recipient of the marketing document and a content from the first and the second information set, the service data and a marketing message into the template; and
f) delivering the marketing document to the receiving address of said recipient.

This invention is further direct to a computer implemented marketing method comprising the steps of:
a) entering a first information set comprising customer information and service provider information of one or more service providers into a computing device (1), said service provider having proficiency to perform a service operation on an article of the customer;
b) entering service data related to performing said service operation on the article into the computing device (1);
c) sending the first information set and the service data to a host computer (5);
d) receiving the first information set and the service data from the computing device (1) into the host computer (5);
e) retrieving a second information set from a first database (16) residing in storage media (6) of the host computer (5) based on the first information set;
f) selecting a template from a second database (14) residing in the storage media (6) of the host computer (5) based on the first information set and the service data;
g) generating a marketing document in the host computer (5) by integrating a receiving address of at least one recipient of the marketing document and a content from the first and the second information set, the service data and a marketing message into the template; and
h) delivering the marketing document to the receiving address of said recipient.

### BRIEF DESCRIPTION OF THE DRAWINGS

FIG. 1 broadly represents the hardware involved in one embodiment of the method of the present invention.

FIG. 2 broadly represents the hardware involved in another embodiment of the method of the present invention.

FIGS. 3A and 3B represent flowcharts that broadly illustrate the steps taking place in the embodiment of the method of the present invention illustrated in FIG. 1.

FIG. 4 represents a flowchart that broadly illustrates the steps taking place in the embodiment of the method of the present invention illustrated in FIG. 2.

FIG. 5A and 5B represent flowcharts that broadly illustrate the steps taking place in another embodiment of the method of the present invention illustrated in FIG. 2.

FIG. 6 is a representation of a graphic user interface screen for entering customer information.

FIG. 7 is a representation of a graphic user interface screen for entering agency information, the service data, and sending the data to a host computer.

FIG. 8 is a representation of a layout of the marketing document generated from the host computer.

FIG. 9 is a representation of a graphic user interface screen for selecting a marketing document for editing and printing.

FIG. 10 is a representation of a graphic user interface screen for editing the marketing document.

FIG. 11 is another representation of a graphic user interface screen for editing the marketing document.

FIGS. 12A, 12B, 12C, 12D, and 12E are representations of graphic user interface screen shots used for creating, customizing and set up of an example of a typical template of the marketing document.

### DETAILED DESCRIPTION OF THE PREFERRED EMBODIMENT

The features and advantages of the present invention will be more readily understood, by those of ordinary skill in the art, from reading the following detailed description. It is to be appreciated that certain features of the invention, which are, for clarity, described above and below in the context of separate embodiments, can also be provided in combination in a single embodiment. Conversely, various features of the invention that are, for brevity, described in the context of a single embodiment, can also be provided separately or in any sub-combination. In addition, references in the singular can also include the plural (for example, “a” and “an” can refer to one, or one or more) unless the context specifically states otherwise.

This invention provides a computer implemented marketing method for marketing business services. The invention particularly provides a computer implemented marketing method to generate a marketing document that relates an article of a customer to services of a service provider who provides service operations on the article of the customer. The invention further provides a computer implemented marketing method to generate a marketing document that relates an article of a customer to services of a service provider who provides service operations on the article of the customer and services of an agency who provides a financial responsibility policy covering at least a portion of a cost of the service operations.

As defined herein:

The term “article” refers to a item of the customer. The customer may own the article directly or be entitled to the article through other means. The article may include, but not limited to, an automotive vehicle, a farm vehicle such as a tractor or lawn mower, an air craft, a water vessel such as a boat or ship, a house, a house appliance such as a heater, furniture, an electronics appliance such as a TV or an air conditioner, a tool, or other consumer goods such as a watch or a piece of jewelry. The customer may pay for a cost for repairing, replacing or maintenance of the article. The customer may also choose to purchase a financial responsibility policy such as a warranty policy or an insurance policy to cover at least a portion of the cost for repairing, replacing or maintenance of the article. The article may be covered by a second financial responsibility policy of a third party. In one embodiment, the article is an automotive vehicle owned by the customer and covered by an automotive vehicle insurance policy held by the customer. In another embodiment, the article is a house owned by the customer and covered by an house insurance policy of the customer issued by an insurance company. In yet another embodiment, the article is an electronic appliance purchased by the customer and covered by an warranty issued by a warranty company. In yet another embodiment, the article is a vehicle entitled to the customer which is owned by a lien holder. In yet another embodiment, the article is a house entitled to the customer and under an mortgage agreement between the customer and a mortgage company. In yet another embodiment, the article is an damaged automotive vehicle of the customer and covered by a second automotive insurance policy of a third party who caused the damage of the vehicle.

“A customer” means a person or an entity who owns or in possession of an article. The customer can possess the article through a financial means such a loan, lease, a mortgage, or any other financial arrangements or agreements. The customer can be a policyholder or a beneficiary of a financial responsibility policy that covers at least a portion of a cost for repairing, replacing, or maintaining the article. For example, the customer can be the owner of an automotive vehicle and a policyholder of an automotive vehicle insurance policy. In another example, the customer can be under obligation to a repair of a damage to the vehicle covered by an insurance policy held by another person who caused the damage to the vehicle. In yet another example, the customer can be an owner of a house and a policyholder of a house insurance policy. In still another example, the customer can be an owner of an electronic appliance and a policyholder of a warranty policy that covers at least a portion of the cost for repairing, replacing, or maintaining the electronic appliance.

“An agency” means a company issuing the financial responsibility policy that covers all of or at least a portion of the cost for repairing, replacing, or maintaining the article within a certain period of time, i.e., warranty period, and under certain conditions set forth by the financial responsibility policy. The term “agency” can also include a representative of the company, such as an employee or a contractor of the company, and an independent agent of the company. The agency can be an issuer or a representative of the issuer of the financial responsibility policy held by the customer. The agency can also be a second issuer or a representative of the second issuer of a second financial responsibility policy held by a third party. In one example, the agency can be an automotive vehicle insurance company that sells and issues insurance policy directly to its customers and process inquiries and claims against the policy. In another example, the agency can be a contractor representing the insurance company who sells the insurance policy and processes inquiries and claims against the policy. In yet another example, the agency can be an independent agent representing one or more insurance companies, sells insurance policies and processes inquiries and claims against the policy. In yet another example, the agency can be an automotive vehicle insurance company issues a vehicle liability insurance policy held by a third party who is under obligation to a repair of a vehicle of the customer.

“Service provider” used herein refers to a person or a business entity that have proficiency to service or repair the article of the customer. The service provider can receive payment from the customer, or from the agency when the article is covered by a financial responsibility policy of the agency to cover all of or at least a portion of the cost of the service or repair. In one example, the service provider can be an automotive vehicle body shop for repairing vehicle bodily damages covered by an insurance policy held by the customer. In another example, the service provider can be an automotive vehicle body shop for repairing a damaged vehicle of the customer wherein the repair is covered by an insurance policy held by a third party who is under obligation to the repair. In yet another example, the service provider can be an electronics repair shop that repairs an electronic appliance of the customer under an warranty policy held by the customer and receives the payment for the cost of the repair from the issuer of the warranty policy. In yet another example, the service provider is a contractor who repairs a damaged house.

“A computing device” includes a desktop computer, a laptop computer, a pocket PC, a personal digital assistant (PDA), a handheld electronic processing device, a mobile phone, a smart phone that combines the functionality of a PDA and a mobile phone, or any other electronic devices that can process information and data. A computing device can have a wired or wireless connection to a database or to another computing device. A computing device can be a client computer that communicates with a host computer in a multi-computer client-host system connected via a wired or wireless network including intranet and internet.

“Service data” include textual descriptions and graphic representations of the article. A textual description of the article include, but not limited to, a description of the article such as a product name or a product model identification, measurement data of the article to be repaired, estimate of repair cost, scheduling data of the service operation such as arrival date or operation date or delivery date. A graphic representation of the article include, but not limited to, still images of the article before the service operation, still images of the article after the service operation, motion images such as a video recording of the article, images of the article under certain conditions such as an X-ray image of the article to reveal damages not visible from the surface or a video recording of visual effects of a surface coating when viewed from varying angles. The service data also include, but not limited to, other notes or records related to the service operation of the article. In one example, the service data include a vehicle identification number (VIN), a color measurement of the vehicle's coating, a formulation of the coating composition, a cost estimate, a scheduled date for the customer to send the vehicle to the body shop, a date by which the vehicle is to be repaired and a delivery date by which the customer is expected to receive the repaired article. In another example, the service data can be X-ray images of a damaged automotive vehicle. In yet another example, the service data can be a video recording of an automotive vehicle body with varying light illumination angles representing visual effects of a surface coating of the vehicle. In yet another example, the service data can be a series of still images of an automotive vehicle body with varying viewing angles with a fixed light illumination angle to represent visual effects of a surface coating of the vehicle.

The term “financial responsibility policy” refers to a written agreement, a contract, or a certificate of certain financial responsibility between a policy issuer and a policyholder who can be a customer. The policyholder pays a premium to the policy issuer and in return, the policy issuer undertakes the financial responsibility of the policyholder for a certain time period and under certain conditions set forth in the policy. Examples of the financial responsibility policy can be automotive vehicle insurance policy, house insurance policy, water vessel insurance policy, house appliance warranty policy, electronics appliances warranty policy, and consumer goods warranty policy. The financial responsibility policy can cover the cost for repairing, replacing or maintenance services of the article. The policyholder can be the customer who owns or in possession of the article, or a third party. There can be a combination of more than one article and/or more than one financial responsibility policies. In one example, the customer can be a policyholder of an automotive vehicle insurance policy who causes a damage to his own vehicle. The customer would typically file a claim and request the insurance company that issued the automotive vehicle insurance policy to pay for the repair of the vehicle. In another example, the third party is a policyholder of an automotive vehicle liability insurance policy who causes a damage to a vehicle of the customer. The third party then requests the liability insurance company to pay for the repair of the vehicle to the customer. In yet another example, the customer who happens to damage his house with his vehicle files a request for covering the costs of repairing the house and the vehicle to the issuer of the vehicle insurance policy and to the issuer of the house insurance policy, both policies being held by the customer.

A “database” used herein refers to a collection of related information that can be searched and retrieved. The database can be a searchable electronic text document, a searchable PDF document, an Microsoft Excel® spreadsheet, an Microsoft Access® database, an Oracle® database, or a Lynux database, each under respective registered trademark. The database can be a set of electronic documents, photographs, images, or drawings, residing in a computer readable storage media that can be searched and retrieved. A database can be a single database or a set of related databases or a group of unrelated databases. “Related database” means there is at least one common information element in the related databases that can be used to related the databases. One example of the related databases can be Oracle® relational databases.

“Customer information” refers to information related to the customer. The information can include, but not limited to, a first name, variations of the first name, a preferred name, a nick name, a last name, a street address, a postal box address, a telephone number, a cell phone number, a pager number, a fax number, an e-mail address, a web address, an electronic file location, a photograph, an identification number or a code assigned to the customer for identification purposes, an account number, a credit card number, an insurance policy identification, an insurance company identification, a warranty policy identification, a warranty issuer's identification, a history of previously received services, a description of previously received services, a credit history, a credit score, a name of a representative, a note, a record, or a comment of the customer. The identification number or the code assigned to the customer can include, but not limited to, an article number, an estimate number, and other codes or identification numbers generated by a service provider during its business practice for identifying the customer.

“Service provider information” refers to information related to the service provider. The information can include, but not limited to, a name, variations of the name, a preferred name, an street address, a postal box address, a telephone number, a cell phone number, a pager number, a fax number, an e-mail address, a web address, an electronic file location, a photograph, a logo, an identification number or a code assigned to the service provider for identification purposes, an account number, a description of available services, service hours, a name of an authorized personnel, or a name of a representative of the service provider.

“Agency information” refers to information related to the agency. The information can include, but not limited to, a name, variations of the name, a preferred name, an street address, a postal box address, a telephone number, a cell phone number, a pager number, a fax number, an e-mail address, a web address, an electronic file location, a photograph, a logo, an identification number or a code assigned to the agency for identification purposes, an account number, a description of available services, service hours, a name of an authorized personnel, a name of a representative, a note, a record, or a comment of the agency.

The term “marketing message” can be a description of services available from the service provider or the agency. The marketing message can be a simple display of a name, an address, or a telephone number of the agency or the service provider so the customer can contact them when a service need arises. The marketing message can also be a photograph, a logo, testimonies from previous customers, a video display, an audio message, other conventional marketing materials, or a combination thereof.

The term “marketing document” refers to a document for marketing purposes. The document can be in forms of a formatted electronic document viewable on a computer, a PDA, a cell phone, a smart phone, a television, or an electronic display device; a printed document printed on a printable medium such as paper, textile, plastic, billboard, vehicle wrapper, or packaging material; a formatted optical document presented on optical media, such as microfilms, photographs, or films; or a combination thereof. The marketing document can also be in an optical or electronic form wherein an image of the marketing document can be projected onto a surface or into a display medium. The marketing document can have texts in one or more selected language, photographs, still images, video clips, or a combination thereof.

The term “marketing agent” means a person or an entity providing marketing services. The marketing agent can be a contractor or a representative of the agency of the financial responsibility, or a contractor or a representative of the service provider. The marketing agent can be an independent person or entity who is authorized to access the information of the customer, the agency information and the service provider information for generating the marketing document to market the services of the agency and the service provider.

The instant invention provides a method of generating a customized marketing document that is generally related to service operations of the article of the customer. The marketing document can be included with other documents related to the article. When a new service to the article is needed, the customer will have ready access to the marketing document and can choose the same service provider for the new service needed. Compared to conventional marketing methods, such as general marketing letters, handouts, marketing fliers, or telephone directory listing, the instant invention provides for a more effective method to market business services, which is described below.

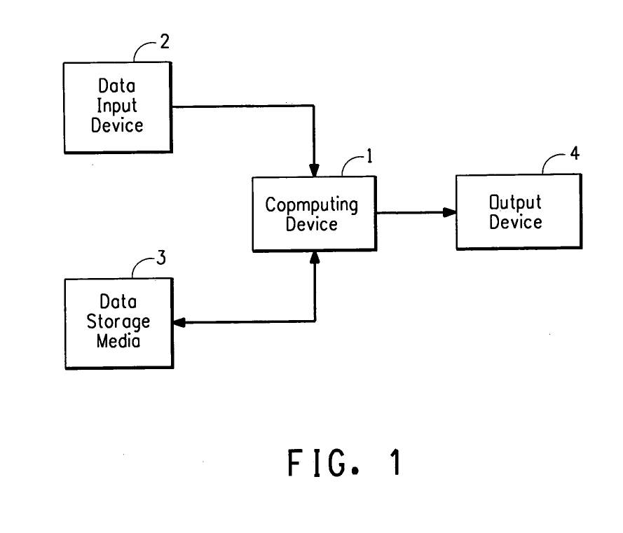

FIG. 1 shows a broad representation of the hardware involved in one embodiment of the method of the present invention, wherein a computing device (1) can have a data input device (2), data storage media (3) and an output device (4). The data input device can be a keyboard, a key pad, a touch pad, a hand-writing recognition device, a still picture camera that records images on digital media, a video camera, a scanner, an electronic reading device that can read electronic data such as a memory card reader, a measurement instrument such as an X-ray detector, a photometer, a spectrometer, a profilometer, or any other devices that can collect data in electronic form and send the data to the computing device (1). The data input device can be another computing device. The storage media (3) can be a hard drive, a floppy disk, a compact disk, a flash memory drive, a portable hard drive, or any other electrical, magnetic, or optical storage media. The output device (4) can be a printer, a data writer, such as a memory card writer/reader, a display device such as a TV, a monitor, or any other devices that can present data output in a print form, an electronic form, or in a visual form. The output device can be the display or the monitor of the computing device. The output device (4) can also be another computing device. The output device (4) can further be a data storage media of another computer. In one example, photos are entered into the computing device (1) via a digital camera as the data input device. In another example, a photograph is scanned into an electronic image file and sent to the computing device via a scanner as the data input device. In yet another example, a video clip is entered into the computing device via a video camera as the data input device. In yet another example, data are transferred to the computing device (1) from another computer as the data input device. Connections between the computing device (1) and the data input device (2) and between the computing device (1) and the data output device (4) can be wired, wireless, or a combination thereof.

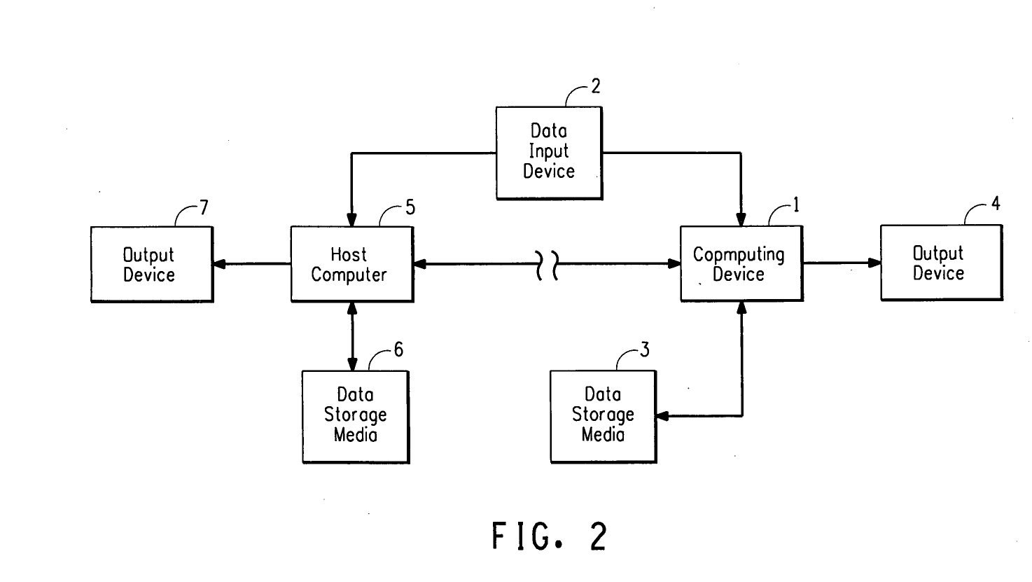

FIG. 2 shows a broad representation of another embodiment of the hardware involved in the method of the present invention. In this hardware configuration, the computing device (1) is connected to a host computer (5) via a wired or wireless connection. Suitable wired connections include, but not limited to, a direct connection cable, a local access network (LAN), an intranet, and an internet. Suitable wireless connections include, but not limited to, an infrared signal connection, a Bluetooth® (registered trademark of BLUETOOTH SIG, INC., Bellevue, Wash. 98004, USA) connection, a cell phone signal network connection, a satellite signal network connection and a broad band wireless signal network connection such as Wi-Fi® (registered trademark of WIRELESS ETHERNET COMPATIBILITY ALLIANCE, INC., San Jose, Calif. 95119, USA) or WiFiMax. Connections between the other devices shown in FIG. 2 can also be wired, wireless, or a combination thereof. The data input device (2) can have a direct connection to the host computer (5). The output device (7) can be a printer, a data writer such as a memory card writer/reader, a display device such as a TV, a monitor, or any other devices that can present data output in a print form, an electronic form, or in optical visual form. The output device (4) can be the display or the monitor of the computing device. The output device (4) can also be another computing device. The output device (4) can further be a data storage media of another computer. The storage media (6) can be one or more hard drives, tape drives, or any other electrical, magnetic, or optical storage media. In one embodiment, a PDA with a built-in camera serves as both the data input device (2) and the computing device (1) and the PDA is connected to the host computer via an infrared wireless connection. In another embodiment, the data input device is a PDA that has data stored in the PDA's memory card. The PDA is connected to the computing device (1) and can transfer the data to the computing device (1) via a wired connection. In yet another embodiment, a computer with a memory card reading slot serves as both the data input device (2) and the computing device (1). In yet another embodiment, a cell phone with a video camera serves as both the data input device (2) and the computing device (1). The cell phone can send data via a cell phone wireless signal network to the host computer (5) that is capable of receiving the data from the cell phone wireless signal network.

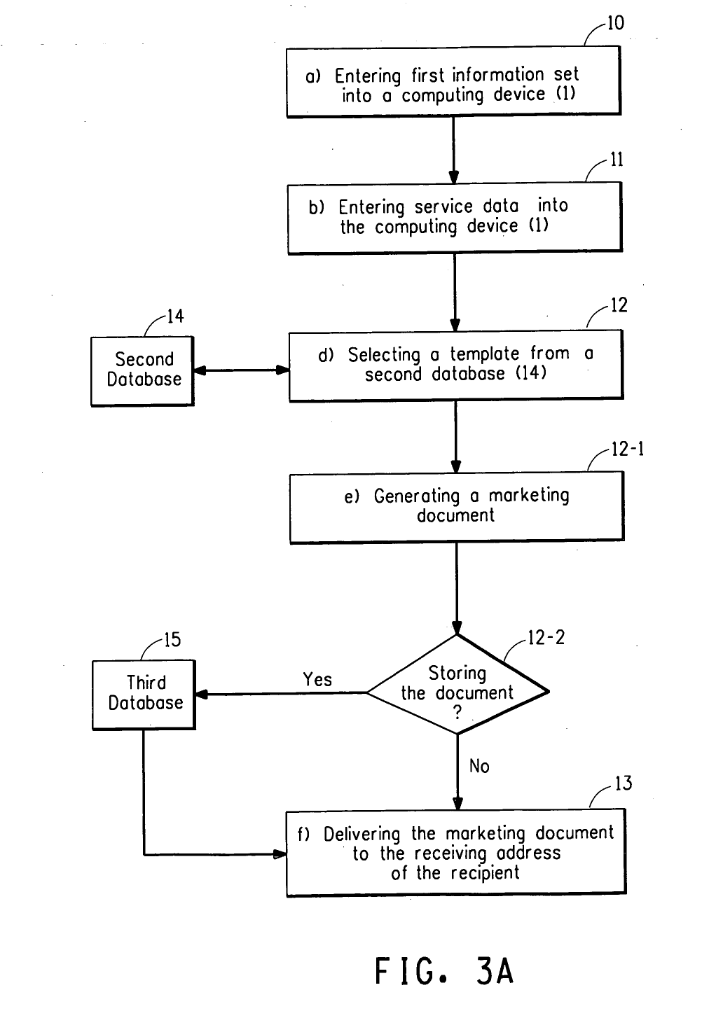

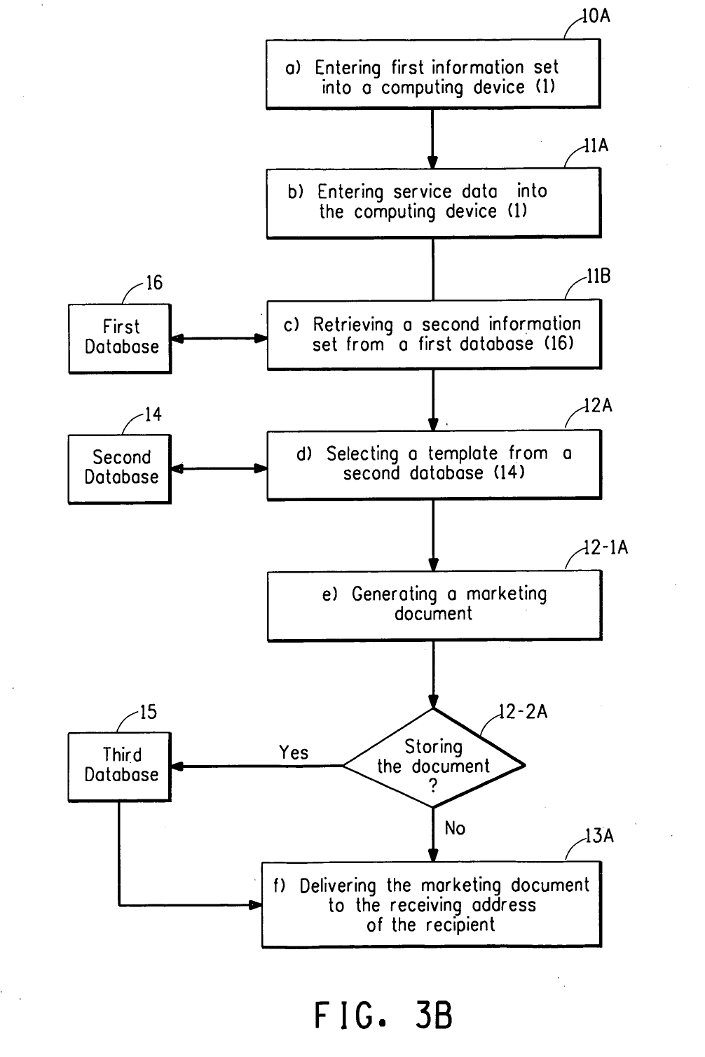

FIGS. 3A and 3B illustrate steps used to generate a marketing document with the hardware configuration shown in FIG. 1.

The instant invention can be provided to a user in the form of a computer readable program product. The user of the invention logs into the computing device (1). The operator is then proceed to step 10 to enter a first information set comprising customer information, service provider information of at least one service provider, and/or information of other parties into the computing device (1). If the operator is the service provider, the service provider information is automatically entered into the computing device at this step during the log on process. The customer information can be typed into the computing device from a keyboard connected to the computing device, imported from another computer, imported from another computer application software product residing in the same computing device, or entered from an electronic data reading device, such as a card reader. In one embodiment, customer information, such as a name and an address of the customer is entered into the computing device by swiping a data storage card through a card reader. Suitable data storage card include, but not limited to, a credit card, an identification card, a service card, or any other cards that have the information stored in the card in an electronic form, a magnetic form, a bar code form, or a perforation code form. In another embodiment, the customer information is imported from an estimating computer program product residing in the same computer. In yet another embodiment, the information is imported from an estimating computer program product residing in a different computer and transferred to the computing device via a wired or wireless connection. If additional parties are involved, information of one or more such parties is entered into the computing device. In one embodiment, an insurance agency can be involved and agency information of the insurance agency can be entered into the computing device. The customer information, the service provider information, and the agency information can include, but not limited to, names, addresses, telephone numbers, fax numbers, e-mail addresses, images, and logos as defined in the text above.

In step 11, service data can be entered into the computing device (1). The service data can include, but not limited to, descriptions of the article to be serviced, images of the article, descriptions of services required, dates of scheduled services, a target date or an actual date for finishing the services on the article, or any other data related to the service operation on the article. If for example, the front hood of a car should be repaired, images of the front hood of the car can be entered into the computing device via a digital camera connected to the computing device together with the make, manufacturing year, color, and vehicle identification number (VIN) of the vehicle. In another embodiment, a video clip of a vehicle can be entered into the computing device as a part of the service data via a video camera connected to the computing device. In yet another embodiment, a video file containing video clips of a vehicle can be transferred to the computing device as a part of the service data. In yet another embodiment, a house is to be repaired for a damage to its siding. Service data including images of the house and the damaged siding are entered into the computing device. Measurement data on the damaged area and a scheduled date for the repair can also be entered as part of the service data. In yet another embodiment, a TV is to be repaired under a warranty policy for a defect in its color display. The service data in this particular embodiment including a description of the defect, images of the defect area, a cause of the defect, a decision on replacing the color display, and an order number for a replacement part can be entered into the computing device (1).

In step 12, a template is selected from a second database (14) from the computing device based on the first information set and the service data.

In step 12-1, a marketing document is generated by integrating a receiving address of at least one recipient of the marketing document and a content from the first information set, the service data and a marketing message into the template.

Selection of the template is based on the first information set and the service data entered in the steps 10 and 11. The template can select a receiving address from addresses available in the first information set. The receiving address can be selected from a street address, a postal box address, a fax number, an e-mail address, a web address, or an electronic file location of the customer. The receiving address can also be a phone number of a phone device such as a video phone or a text/image enabled cell phone, that can receive and display electronic text and image documents. For a marketing document printed on paper, a preferred receiving address can be selected from the street address, the postal office box address, the fax number of the customer. For a marketing document in electronic form, a preferred receiving address can be selected from the e-mail address, the web address, or the electronic file location of the customer. The receiving address can also be selected from the address of the agency, such as a street address, a postal box address, a fax number, an e-mail address, a web address, or an electronic file location of the agency.

A template can be configured to select one address from the available addresses of the customer or the agency. When more than one address is available for the customer, a preferred address can be designated as the receiving address. Alternatively, different template can be created to use different addresses. In one embodiment, a template can be configured to select the street address of the customer as the receiving address. In another embodiment, a template can be configured to select the e-mail address of the customer as the receiving address. In yet another embodiment, a template can be configured to select the street address of the agency as the receiving address. The computing device can be configured to automatically select a default template. The templates can also be selected manually from the computing device by an operator.

The template can also define what type of marketing document to be generated based on available service data and select a content from the available service data. The template can be edited or customized. A new template can be created. The modified or newly create templates can be stored in the second database or a temporary data location residing in the storage media of the host computer.

Selection of the template and the selection of the receiving address are further described with following embodiments.

In one embodiment in which a car of the customer needs to be repaired, the customer can choose to use her car insurance policy to pay for the repair and can choose to perform the repair in the same body shop. The customer information, the service provider information on the car repair body shop, and the agency information on her car insurance agency can be entered into a computing device at the body shop in the step 10 as the first information set. Available service data including images of the damaged car, a scheduled date for the customer to drop off the car at the body shop and measurement data on the color of the car are entered into the computing device in step 11. Due to the availability of the agency information and the scheduled date, a template of “Agent Letter Scheduled” is then selected in step 12. Based on the template of “Agent Letter Scheduled”, the computing device may integrate the name including the first name and the last name of the customer, a receiving address selected from a street address of the customer, a content including an address and a telephone number of the insurance agency, an address and a telephone number of the body shop, the date of scheduled services selected from the first information set, and a marketing message into the template to generate a marketing document. The marketing message can be configured in the template. A one of ordinary skill in the art can configure the template to include additional content such as an insurance claim identification, a photograph or a logo of the insurance agency, a photograph or a logo of the body shop, a name and a telephone number of a person of the body shop who handles the service operation, or photographs of the damaged car in the marketing document. The marketing message can be additional descriptions of available services from the agency or from the service provider. The marketing message may be a simple display of the name, the address, or the telephone number of the agency or the service provider so the customer may use when a new service need arises in the future.

In another embodiment, the customer can choose not to use her car insurance policy to pay for the repair and can be undecided on whether to use the body shop to perform the repair. No information on the agency nor scheduled date for service operation can be entered in the steps 10 and 11. A template of “Shop Letter Unscheduled” can be selected. The marketing document generated based on the template of “Shop Letter Unscheduled” can have at least a name and a receiving address of the customer, a thank-you message from the template, a content including an address and a telephone number of the body shop selected from the first information set, and a marketing message describing available services of the body shop. The marketing document can further have a photograph or a logo of the body shop, a name and a telephone number of a person of the body shop who handles the service operation, a description of services available from the service provider, or photographs of the damaged car.

In yet another embodiment, the customer can choose to use the body shop to repair the car, but can decide not to use his insurance policy to pay for the repair. A date for the service operation can be entered in the step 11 and no information on the agency can be entered in the step 10. A template of “Shop Letter Scheduled” can then be selected. The marketing document generated based on the template of “Shop Letter Scheduled” can have at least a name and a receiving address of the customer, a thank-you message from the template, a content including an address and a telephone number of the body shop, the date of the scheduled service operations selected from the first information set, and a marketing message describing available services of the body shop. The marketing document can have additional information, such as a name and a telephone number of a person of the body shop who handles the service operation or instructions on where and when to drop off the car for the scheduled services. The marketing document can further have a photograph or a logo of the body shop, a description of services available from the body shop, or photographs of the damaged car.

In yet another embodiment, the customer can decide not to use the body shop to repair the car after visiting the body shop. A template of “Thank You Letter” can then be selected. The marketing document generated based on the template of “Thank You Letter” can have at least a name and a receiving address of the customer, a thank-you message from the template, an address and a telephone number of the body shop selected from the first information set, and a marketing message describing available services of the body shop. The marketing document can have additional information, such as a photograph or a logo of the body shop, a name and a telephone number of a person of the body shop who handles the service operation, a description on available services from the body shop, or photographs of the damaged car.

In yet another embodiment, the customer can decide to use the body shop to repair the car. The cost of the repair is paid for by a second insurance policy held by a third party who is under obligation to the repair of the car of the customer. A marketing document is generated after the repair is completed. A second template of “Thank You Letter” can then be selected. The marketing document generated based on the second template of “Thank You Letter” can have at least a name and a receiving address of the customer, a thank-you message from the second template, a content including an address and a telephone number of the body shop selected from the first information set, and a marketing message describing available services of the body shop. The marketing document can have additional content such as a photograph or a logo of the body shop, a name and a telephone number of a person of the body shop who handles the service operation, a description on available services from the body shop, an address and a telephone number of the second insurance agency representing the second insurance policy held by the third party, or photographs of the car before and after the repair.

A one of ordinary skill in the art can change or modify the configurations of the computing device and the configurations of the template according to conventional methods well known in the industry. The receiving address can further be edited, modified, or changed after the marketing document is generated in editing and customization processes described in other embodiments of this invention.

Designations and contents of the templates can be modified and customized by a person with ordinary skill in the art and has appropriate access privileges. New templates can also be created. Creating, modifying and customizing the templates are described in detail in other embodiments of these invention described below.

Although in the embodiments described above, the customer is selected as the recipient of the marketing document and one address of the customer is selected as the receiving address, other person or entity may be selected as a recipient. For example, the agency or the third party can be selected as the recipient. More than one receiving address or more than one recipient can be integrated in the marketing document. In one embodiment, the marketing document can have receiving addresses of both the customer and the insurance agency of the customer.

Selection of the template, selection of the receiving address of the recipient of the marketing document, and integration of the information and the data can be done manually or automatically by the computing device with appropriate configurations. The configurations can be done with conventional methods and techniques well known in the industry. In one embodiment, the configuration is done with a set of computer readable codes in Java programming languages such as Java™ (registered trademark of the Sun Systems, Santa Clara, Calif. 94054, USA). Computing readable codes in other programming languages, such as C++, may also be suitable for the configuration of the computing device.

In step 12-2, the marketing document generated in steps 12 and 12-1 can be sent to the output device (4), such as a printer, directly without being stored electronically. The marketing document can be stored in a third database (15). It is preferred to store the marketing document electronically in the third database. The marketing document may be further edited or customized. The edited or customized marketing document can also be stored in the third database and can be retrieved.

In step 13, the marketing document is delivered to the receiving address of the recipient. When the receiving address is a street address, the marketing document is printed with a printer and mailed to the receiving address of the recipient via a delivery service such as a postal service, an express mail service, or other services delivering printed materials. When the receiving address is an e-mail address, a web address, or an electronic file location, the marketing document is delivered electronically to the address via e-mailing, file transferring, or uploading. The marketing document can also be delivered to a cell phone or a PDA phone that can receive electronic documents by sending the document to the phone number associated to the cell phone or the PDA phone.

The customer information, the service provider information, the agency information or other parties' information can be stored in a first database (16) accessible from the computing device (1). The first database can be residing in storage media of the computing device, or residing in remove storage media connected to the computing device via a wired or wireless connection. The first database (16) is preferably residing in the storage media (3) of the computing device (1). The information can be indexed and retrievable electronically. The first database can be a single database or a set of related databases. In one embodiment, a single first database comprises the customer information, the agency information and the service provider information. In another embodiment, the first database comprises 3 related databases.

When the first database is used, the method of this invention can be illustrate by the following steps as shown in FIG. 3B.

In step 10A, only identifiers that represent the information needed to identify the customer, the service provider, or the agency are entered into the computing device in a first information set. Each party can have its own identifier or multiple identifiers. A suitable identifier for the customer can a name, a telephone number, an identification number or a code, or an address of the customer. A suitable identifier for the service provider can be the name, a logon identification such as a username and a password, a telephone number, an identification number or a code, or an address of the service provider. A suitable identifier for the agency can be a name, a telephone number, an identification number or a code, or an address of the agency. Each party can be identified by one or more identifiers. In one embodiment, a customer is identified with a name including a first name and/or a last name of the customer, a customer number assigned to the customer by the service provider, an address of the customer, or a telephone number of the customer. In another embodiment, an insurance agency is identified with a name, a insurance identification number, a street address, or a telephone number of the insurance agency. In another embodiment, a service provider is identified with a shop identification code assigned to the service provider.

In step 11A, service data can be entered into the computing device (1) in a way similar to that of the step 11.

In step 11B, the identifiers entered in the first information set are used to retrieve a second information set from the first database (16).

In step 12A, a template is selected based on the first information set, the second information set, and the service data entered.

In step 12-1A, a marketing document is generated by integrating a receiving address of at least one recipient of the marketing document and a content from the first information set, the service data and a marketing message into the template as described in the step 12-1.

In step 12-2A, the marketing document generated in steps 12A and 12-1A may be sent to the output device (4), such as a printer, directly without being stored electronically. The marketing document may be stored in a third database (15). It is preferred to store the marketing document electronically in the third database. The marketing document may be further edited or customized. The edited or customized marketing document may also be stored in the third database and can be retrieved.

In step 13A, the marketing document is delivered to the receiving address of the recipient as described in the step 13.

In one embodiment, the first information set comprises customer information, agency information and service provider information. The customer information is entered into the computing device by selecting from a list listing names of the customers stored in the storage media (3) of the computing device (1). The agency information is entered into the computing device by selecting from a pull-down menu that shows names of available agency stored in the storage media (3) of the computing device (1). The service provider information is entered into the computing device by selecting from a service provider list. The lists of customers, the service provider, and the pull-down menu can an integral part of the first database (16) or a subset of the first database. A one of ordinary skill in the art can configure the first database, the lists, and the pull-down menu with methods well known in the industry. The second information set of the customer is retrieved from the first database based on the customer information in the first information set and can include, but not limited to, an e-mail address, a street address, a telephone number, a cell phone number, a customer code, or a history of previous services of the customer. The second set of agency information is retrieving from the first database and can include, but not limited to, a photograph, a street address, a company name, a telephone number of the agency and a photograph, a street address, a company name, a telephone number of a representative of the agency. A date is scheduled for the service and data on the service operation is entered into the computing device. The template selected from the second database (14) causes to the computing device to generate a marketing document having the e-mail address of the customer as one receiving address, and the street address of the representative of the agency as a second receiving address. The marketing document can be edited, further customized and/or stored in the third database (15). The marketing document is then delivered to the e-mail address of the customer electronically. The marketing document is also printed onto paper and mailed to the street address of the representative of the agency.

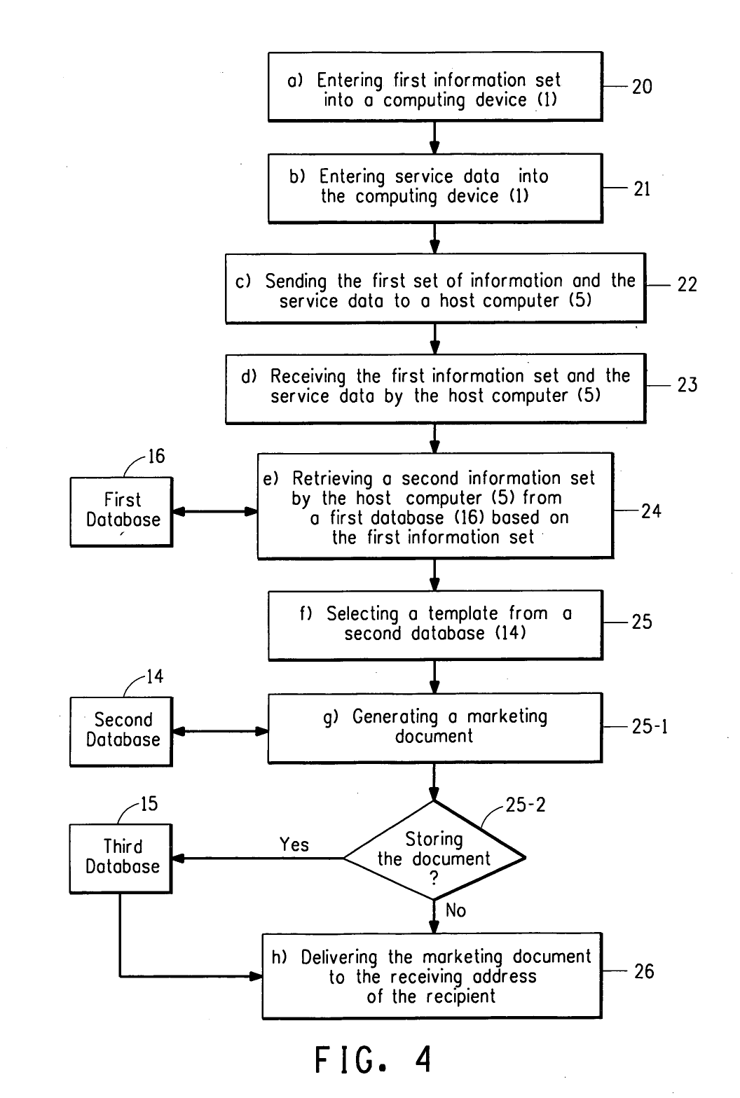

The instant invention also provides a method to generate a marketing document with the hardware configuration shown in FIG. 2. This configuration comprises at least one computing device (1) and at least one host computer (5). FIG. 4 illustrates steps taking place in this client-host computer configuration.

In step 20, a first information set is entered into the computing device (1). The information can be typed in or selected from a list or a pull-down menu as described in steps 10 and 10A.

In step 21, service data are entered into the computing device (1) as described in steps 11 and 11A.

In step 22, the first information set and the service data are sent to the host computer (5) and received by the host computer (5) in step 23.

In step 24, the host computer retrieves a second information set from the first database (16) based on the first information set and the service data received.

In step 25, a template is selected from the second database (14) based on the first information set, the service data and the second information set. The template can be an “Agent Letter Scheduled”, a “Shop Letter Scheduled”, a “Shop Letter Unscheduled”, or a “Thank You Letter” as described before.

In step 25-1, a marketing document is generated by integrating a receiving address, a contents from the first information set, the service data and the second information set, and a marketing message into the template.

In step 25-2, the marketing document can be directly delivered to the receiving address of the recipient in the delivering step (26) or stored in the third database (15) and then delivered to the receiving address of the recipient. It is preferred to store the marketing document electronically in the third database (15).

The marketing document can be edited or further customized as described in other embodiments of this invention.

The marketing document can be generated by an employee or a representative of the service provider, an employee or a representative of the agency, or a employee or a representative of an independent marketing agent. The independent marketing agent can be specialized in marketing services and can have business relationship established with the service provider or the agency.

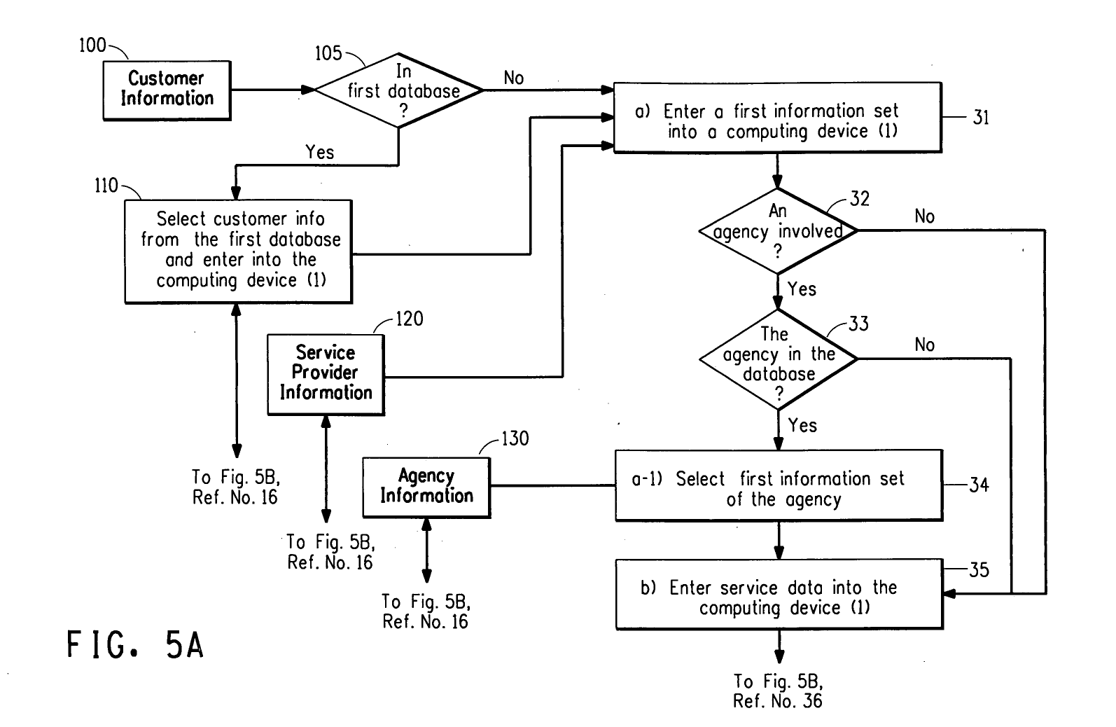

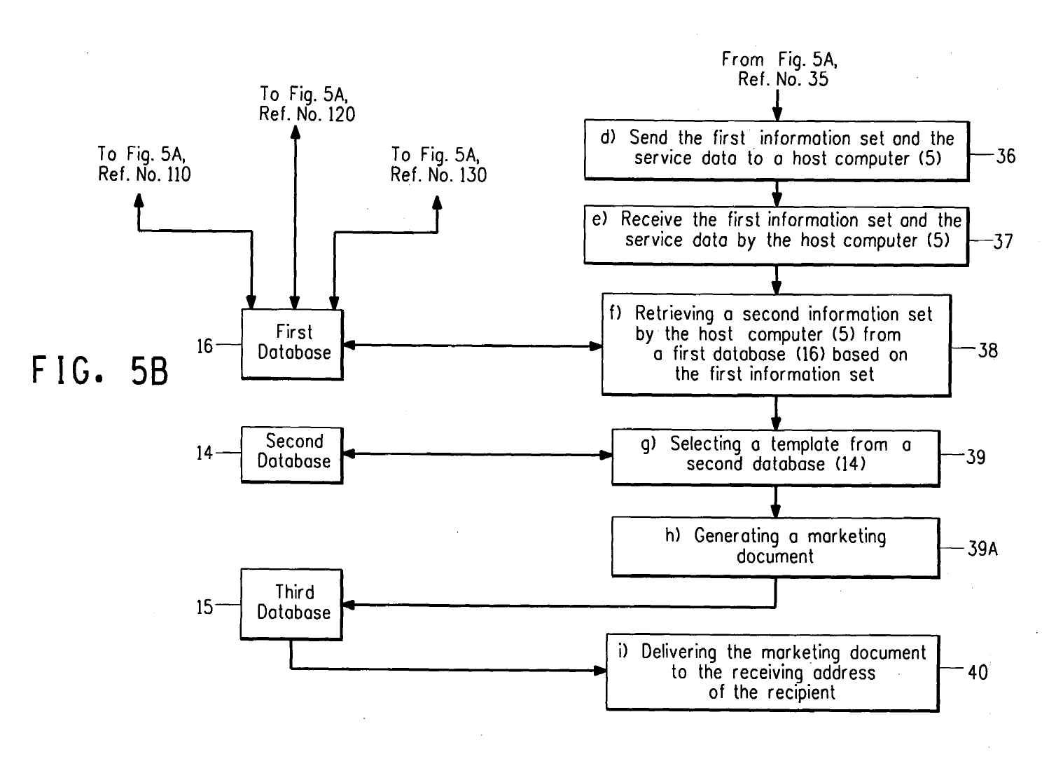

This invention can be further described with a preferred embodiment illustrated in FIGS. 5A and 5B.

In this preferred embodiment, a marketing letter is generated to market services provided by an automotive vehicle body repair shop, hereafter referred to as the body shop. The article to be repaired is an automotive vehicle of the customer wherein the vehicle's body is damaged in an accident. The customer is the owner of the vehicle. The agency is a representative of an automotive insurance company. The financial responsibility policy is an automotive insurance liability policy issued by the automotive insurance company and held by a third party who caused the accident. The computing device is a computer at the body shop. The body shop has multiple locations. Only one location is involved in the repair service of the damaged vehicle. The body shop provides an estimate on the cost of the repair operation. The estimate is performed with a conventional estimator system such as the Mitchell provided from Mitchell Electronic Products (San Diego, Calif. 92150), Shoplink from ADP (Roseland, N.J. 07068), or from CCC Information Services Inc.(Chicago, Ill. 60654).

In step 31 of this embodiment, an operator logs onto the computer and enters information of the body shop (120) into the computer by selecting a location from a body shop location list. Customer information (100) comprising a first name, a last name, a street address, a telephone number, an estimate identification code assigned to the customer by the body shop, is entered into the computer by selecting from a customer list imported from the estimator system.

In step 32, the operator is then check whether an insurance agency is involved. There is an insurance agency in this embodiment. In step 33 the operator checks whether the agency is in the database by opening a pull-down menu showing a list of insurance agencies (130) available in the first database. The list of insurance agency (130) is residing in the computer and periodically synchronized with the first database (16) by conventional process well known in the industry. An identifier of the insurance agency, in this case the identifier is the name of the agency, is entered into the computer by selecting from the pull-down menu (step 34). If no agency is involved or the agency is not shown in the list of insurance agency, the operator will select “None” or a blank as an identifier for the agency and proceed directly to step 35.

In step 35, service data are entered into the computer. In this embodiment, service data include two images of the vehicle, a schedule date for the customer to drop off the vehicle, a target date for finishing the repair service, a name of a representative of the body shop who handles the repair. The images of the vehicle are entered into the computer from a digital camera by connecting the computer and the camera and transferring the images from the camera to the computer by a conventional file transfer process.

In step 36, the first information set comprising the body shop information, the customer information, and the identifier of the insurance agency, and the service data are sent to a host computer.

In step 37, the host computer receives the first information set and retrieves a second information set from the firs database (16) in step 38 based on the first information set and the service data received. In this embodiment, a photograph of a representative of the insurance agency, a street address and telephone number of the representative of the insurance agency, a website address of the insurance agency, a logo image of the body shop, a street address and a telephone number of the body shop, and a website address of the body shop are retrieved as the second information set for this embodiment. No additional information on the customer is available in the first database.

In step 39, based on the information of the insurance agency, the scheduled date for drop off of the vehicle, and the images of the vehicle, a template of “Agent Letter Scheduled” is selected from the second database (14). Based on the template, the street address of the customer is selected as the receiving address of the marketing document. The template also contains a pre-defined text message.

In step 39A, a marketing document is generated by integrating the receiving address, a content selected from the first name of the customer, the photograph of the representative of the insurance agency, the street address and the telephone number of the representative of the insurance agency, the website address of the insurance agency, the logo image of the body shop, the street address and the telephone number of the body shop, and the website address of the body shop, the images of the vehicle, and a marketing message into the template. The document is generated in a suitable electronic format such as a Microsoft® WORD file, a Microsoft® PowerPoint file or an Adobe® PDF file, wherein Microsoft® is a registered trademark of Microsoft Corporation (Redmond, Wash. 98052, USA) and Adobe® is a registered trademark of Adobe Systems (San Jose, Calif. 95110, USA). The PDF file format is preferred.

The marketing document can be directly delivered to the receiving address without being stored or stored in a computer readable storage media such as the third database (15) residing in the host computer or other electronic memory device such as a memory card or a flash memory drive connected to the host computer or another computer in the computer-host computer system represented in FIG. 2. It is preferable to store the marketing document electronically in a retrievable database. A preferable storage database is the third database (15). The marketing document can be further edited and customized. The operator can verify the customer's name and address, edit or customize the text message, or change to other types of templates.

In step 40, the marketing document is delivered to the receiving address. In this embodiment, the receiving address is the street address of the customer. The marketing document is printed onto a piece of paper and mailed to the receiving address through a postal mail service.

In the preferred embodiment described in the steps 31 through 40, the customer information can be entered into and stored in the first database. The information can be retrievable for later use.

In the preferred embodiment described in the steps 31 through 40, an address of the third party can be entered into the marketing document so the marketing document can be delivered to the third party to market the repair services of the body shop.

In the preferred embodiment described in the steps 31 through 40, if the agency is not in the first database (16), a request can be generated by the operator and the agency information can be entered into the database following conventional business procedures.

In the preferred embodiment described in the steps 31 through 40, if the insurance agency is located outside of the service area of the body shop, the operator can choose to select a template excluding the agency's information to focus on marketing the services of the body shop.

In the preferred embodiment described in the steps 31 through 40, the operator can be an employee or a representative of the body shop, an employee or a representative of the insurance agency, or a employee or a representative of a marketing agent. The marketing agent can be specialized in marketing services and can have business relationship established with the body shop and/or the insurance agency.

In the preferred embodiment described in the steps 31 through 40, a video file showing video recording of the vehicle can be used as part of the service data and integrated into the marketing document. When the video file is used, a preferred form of the marketing document can be an electronic format suitable for presenting the video file. Suitable electronic format include, but not limited to, a Microsoft® PowerPoint file, a Windows® Media Player file, an AVI (Audio Video Interleave, Microsoft®), or an MPEG file (the Motion Picture Experts Group).

In the preferred embodiment described in the steps 31 through 40, multiple computing devices can be connected to the host computer. The host computer can comprise more than one computers. The multiple computing devices and the multiple host computers can be connected via wired or wireless connections to form a network as well known in the industry and can be modified into different configurations by a person or persons skilled in the art.

In the preferred embodiment described in the steps 31 through 40, specific devices, file format, and specific process are described. It is understood that a one of ordinary skill in the art can choose different devices, file format, or process without departing from the spirit of this invention. It is also understood that a one of ordinary skill in the art can perform the steps in sequential orders different from the sequential order described in the embodiment. For example, the agency information can be entered into the computer before the customer information is entered.

### EXAMPLES

The present invention is further defined in the following Examples. It should be understood that these Examples, while indicating preferred embodiments of the invention, are given by way of illustration only. From the above discussion and these Examples, one of ordinary skill in the art can ascertain the essential characteristics of this invention, and without departing from the spirit and scope thereof, can make various changes and modifications of the invention to adapt it to various uses and conditions.

### Example 1

### Entering First Information Set and Service Data

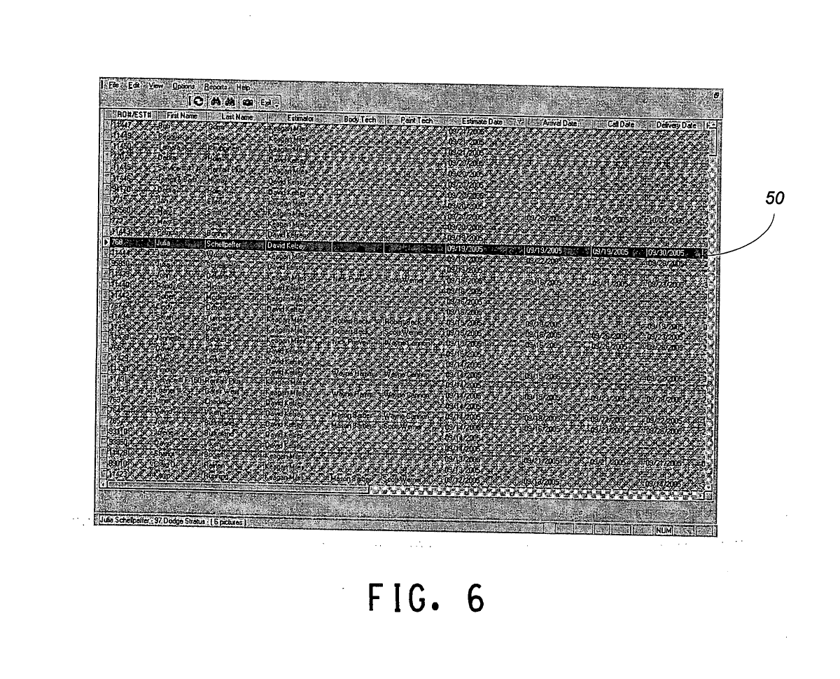

In this example, the first information set comprises customer information, agency information and body shop information. The customer information is exported from an estimator system. An operator logs on to a computer at the body shop and opens a graphic user interface screen as shown in FIG. 6. By logging on, an identifier of the body shop is selected and is included in the first information set. The customer is identified with a first name, a last name and a date of service as shown in a line (50) in FIG. 6. By double-clicking the line (50), the customer information was entered into the computer.

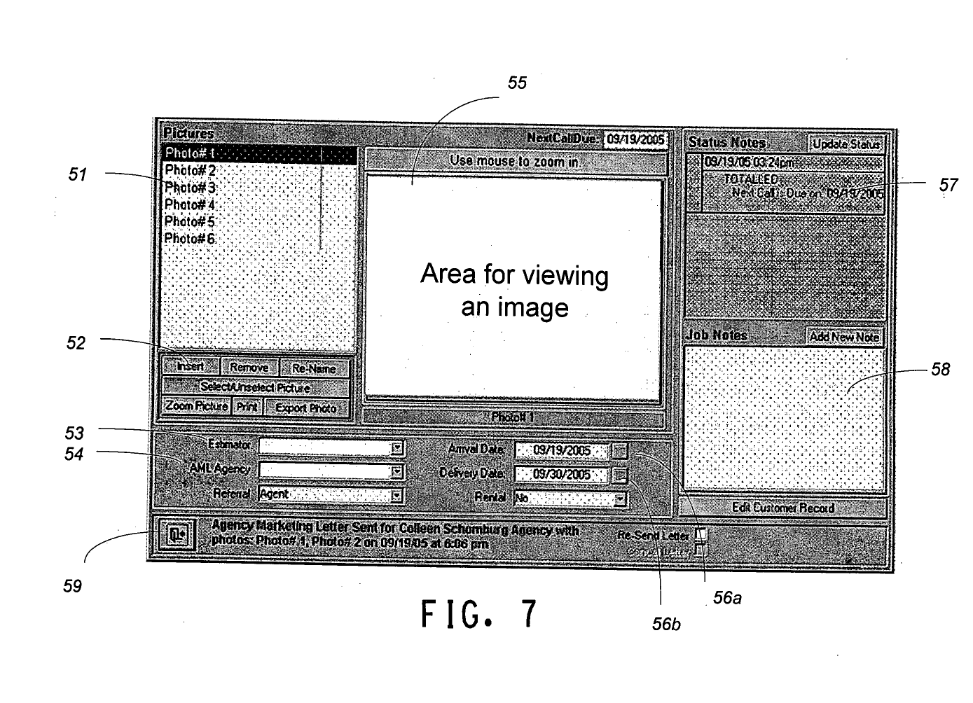

FIG. 7 shows a graphic user interface, thereafter referred to as the interface, for entering agency information and service data. Images of a car to be repaired can be obtained from a digital camera connected to the computer and a list of images is shown in the selection area 51 of the interface. By clicking on one of the photos listed in the area 51, the image can be viewed in the area 55 of the interface. The image can be inserted into the client computer by clicking on the “Insert” button in the area 52 of the interface. A name of the person who performed the estimate can be entered by selecting from a pull-down menu in the area 53. A name of the agency can be entered by selecting from a pull-down menu in the area 54. If no agency is involved, the field can be left blank, or by selecting “None” or “Agent Out of Area”. Arrival (drop off) and delivery (targeted finish) scheduled dates can be entered in the area 56a and 56b, respectively. Other service data can be entered in the areas 57 and 58 of the interface, respectively. The interface can be further modified or customized to add more data types as determined by a one of ordinary skill in the art.

After the first information set and the service data are entered, the button 59 can be clicked to send the first information set and the service data to a host computer.

### Example 2

### Marketing Document

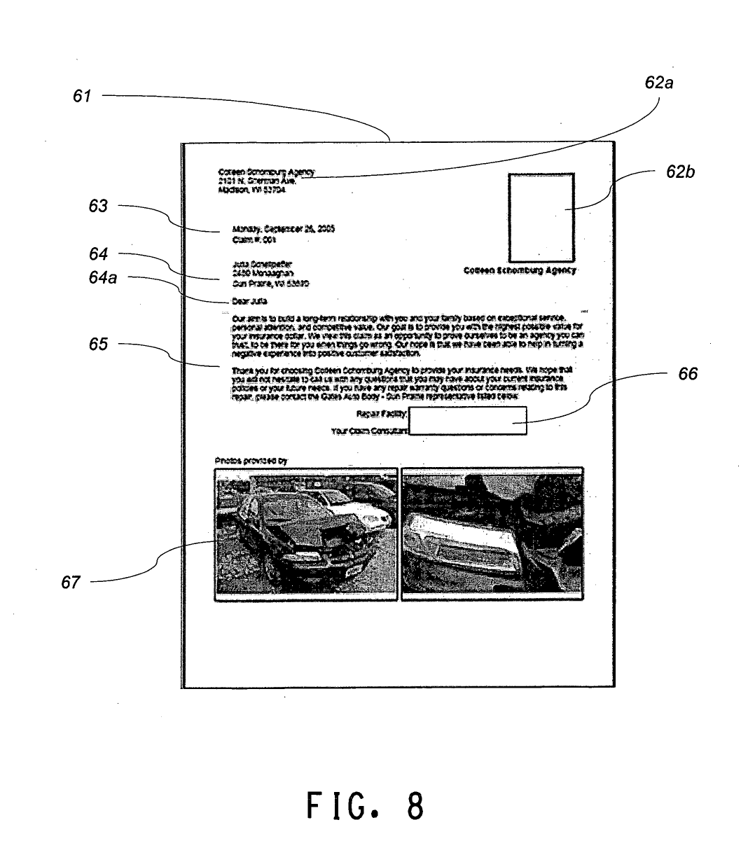

This example shows a representative layout of a marketing document (FIG. 8). The document is preferably generated in an Adobe® PDF format and can be printed on paper or delivered electronically and viewed from a device that is capable of displaying a PDF format file.

The marketing document 61 includes a description, such as a name and an address of an insurance company 62a; a logo or photograph of a representative of the insurance company 62b; date and insurance claim identification 63, name and a receiving address 64, text messages 64a and 65, name and a contact telephone number of the body shop 66, and images of the vehicle to be repaired 67. When the marketing document is generated before the vehicle is repaired, the images of different views of the damaged vehicle can be included. When the marketing document is generated after the repair is finished, the images of the vehicle before and after the repair can be included.

The marketing document can have additional contents, such as the vehicle identification number (VIN) of the vehicle, a website address where the customer can log in to obtain an update of the repair operation, a logon ID and password for the customer to log on to the website.

The marketing document shown in FIG. 8 is only a representation of various types, formats and layouts of a marketing document. One of ordinary skill in the art can choose different layout, format, or choose to include different information or data, or use different artistic presentation, without departing from the spirit of this invention.

### Example 3

### Editing Marketing Document

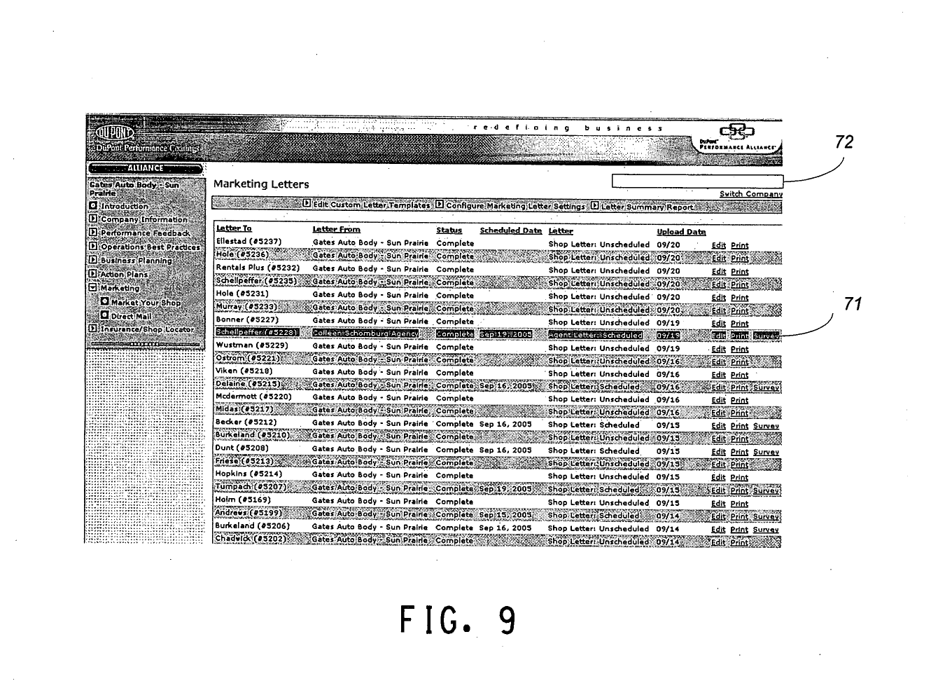

This example shows a representative process used to edit a marketing document (FIGS. 9, 10 and 11).

In this example, a list of marketing documents can be made available from the host computer once an operator is logged on to the host computer. A specific marketing document can be edited or printed by clicking on appropriate buttons, such as “Edit” or “Print” in area 71 of the user interface screen shown in FIG. 9. An identifier, such as a name or an address of the service provider, such as the body shop, can be displayed in area 72 of the interface screen.

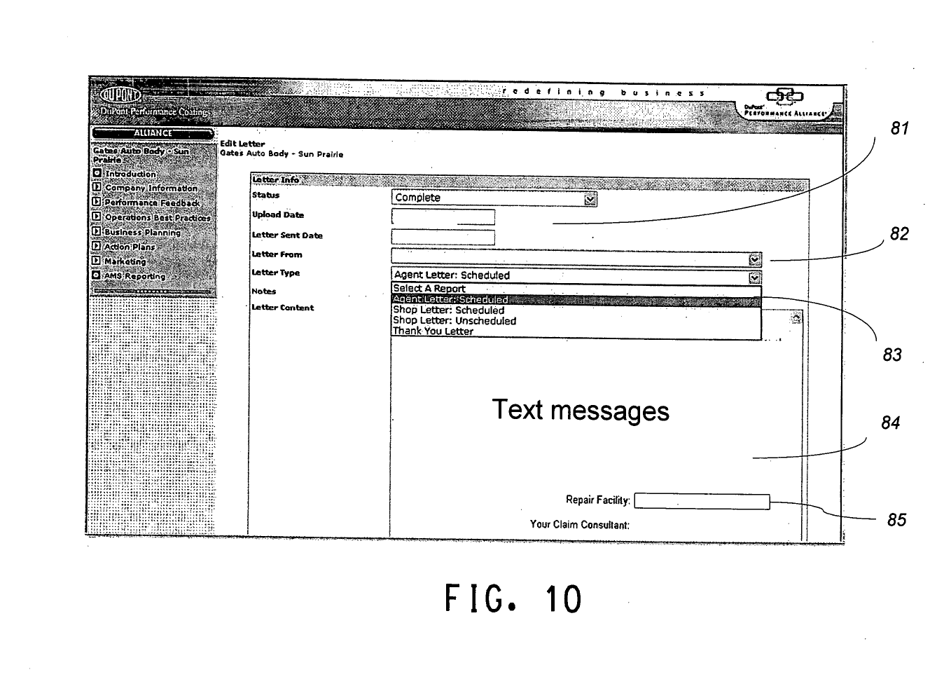

After the “Edit” button is clicked, an edit interface screen opens (FIG. 10). Different parts of the marketing document can be edited. Status of the repair operation and dates can be edited in the area 81 of the edit interface screen. Information about a sender of the marketing document can be entered or changed in the area 82. The marketing document can use the body shop as a sender, or use an insurance agency as a sender if the insurance agency information is available. A different template can selected from a pull-down menu in the area 83. Text messages can be edited or modified in the area 84. A name of the body shop can be shown in area 85. The marketing document can be saved after editing by clicking on a “Save” or “Submit” button (not shown in FIG. 10).

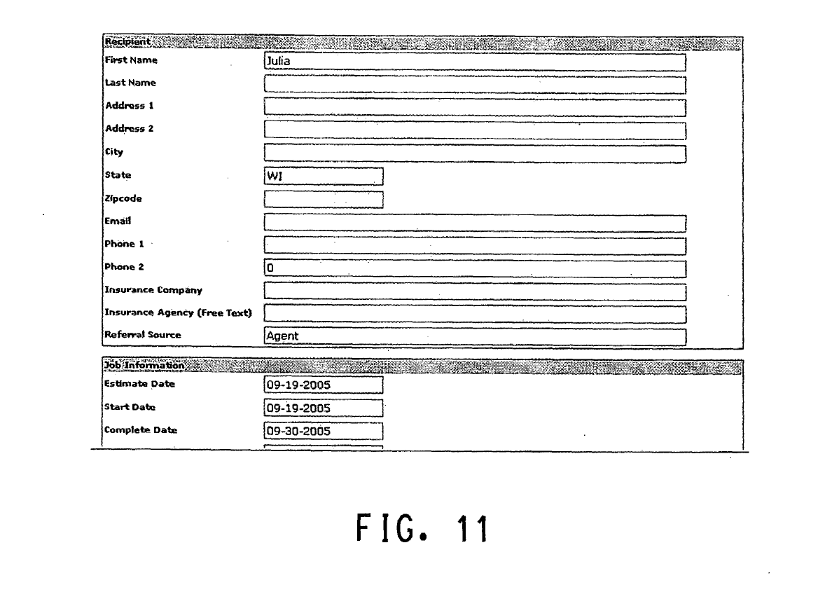

The receiving address and the name of the recipient, some of the service data, such as estimate data, start date, or completion date, can be edited or modified from the edit interface screen shown in FIG. 11. Insurance agency information and other notes can be also entered in this interface screen.

The marketing document can be saved at any time during or after editing by clicking on a “Save” or “Submit” button (not shown in the Figures).

### Example 4

### Creating and Customizing Template

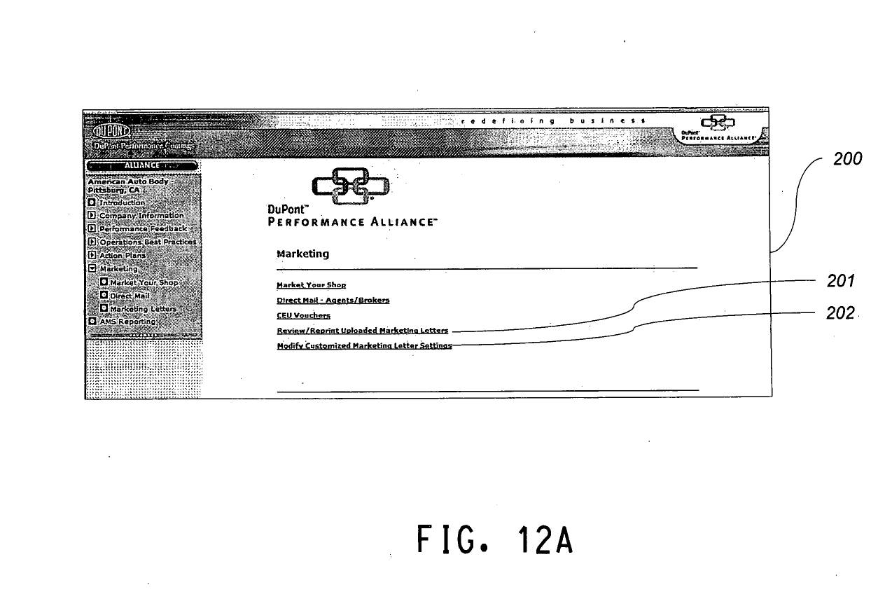

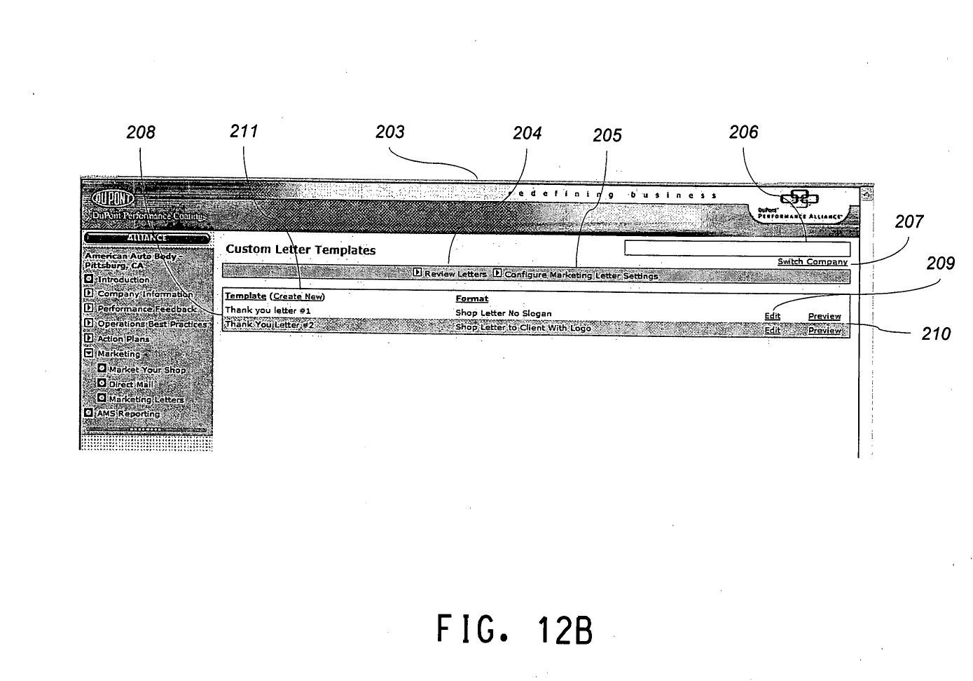

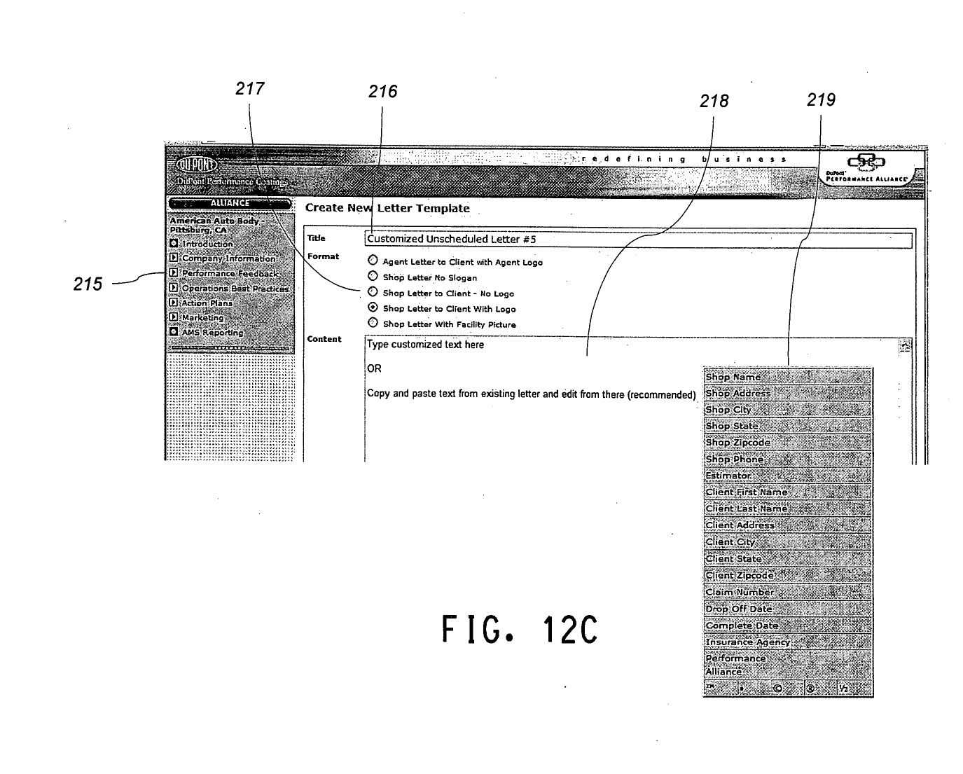

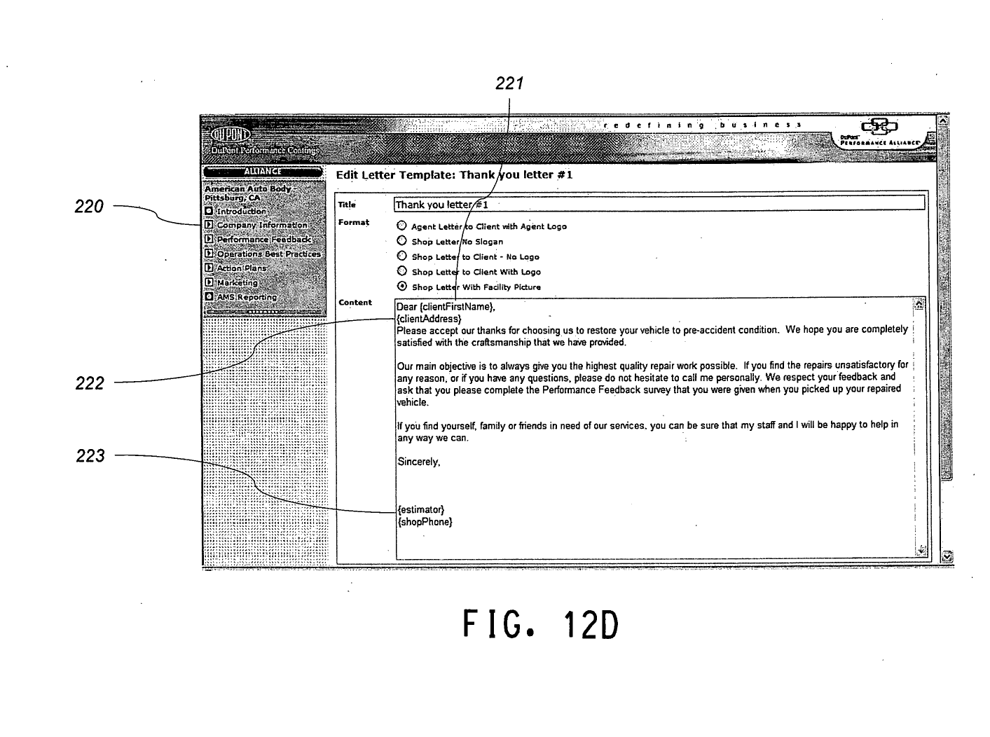

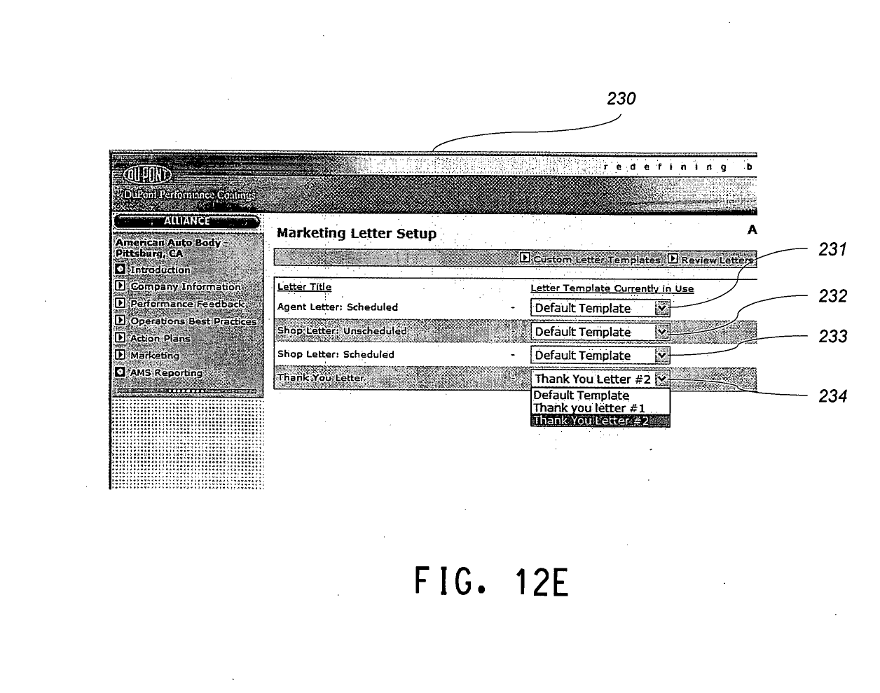

This example shows a representative process used to create a new template. A graphic user interface screen 200 is shown in FIG. 12A. From this interface, a previously generated marketing document can be reviewed or printed via a link 201. To create a template, a link 202 is clicked to open a template interface 203 (FIG. 12B). On the template interface 203, links are provided for reviewing marketing documents (204) or configuring document settings (205). A name of the service provider is shown in the area 206. Different service providers can be selected by following the link 207. A list of available templates created previously is shown in the area 208 of the interface screen. Those previously generated templates can be edited (209) or previewed (210) by clicking on an appropriate link. To create a new template, the link 211 needs to be clicked to open a create new template interface screen 215 (FIG. 12C).

A descriptive title of the new template can be entered into the title area 216. A format is selected from one of the available formats in the area 217. Text messages can be entered in the text area 218. Text from an existing document is preferably copied and pasted into the new template. A list of pre-defined text field 219 can be also made available to the user. The pre-defined field provides links to the phrases in one of the databases. A pre-defined computer readable algorithm can insert the pre-defined phrases into the text field. When the phrases are updated or modified in the databases, the text fields in the marketing document can be also updated automatically.

Examples of such phrases are shown in FIG. 12D. In the text field of the new template, a string {clientFirstName} (221) is inserted into a place where a first name of a client is to be displayed in the final marketing document. When this template is used and a customer's first name is available, the host computer will retrieve the first name of the customer and automatically insert it into the place. Similarly, a receiving address can be defined by a string {clientaddress}, a name of an estimator can be defined by a string {estimator}, and a telephone number can be defined by a string {shopPhone}.

Once a new template is created, use of the template can be further configured in a setup interface screen 230 (FIG. 12E). From this setup interface, each type of marketing document can have a preferred template. The preferred template can be a default template or a template defined and selected during the setup process. A default template is a template already existing in the second database and is to be used if no other setup is available. For example, when an “Agent Letter Scheduled” is to be generated, the template can be defined to be the default one or a newly generated one (231). Similar setting can be used for “Shop Letter Scheduled” (232), or “Shop Letter Unscheduled” (233) where the default template is set in place. For a “Thank You Letter”, the template “Thank You Letter #2” can be configured to be the preferred template whenever a “Thank You Letter” is to be generated (234).

1. A marketing method comprising the steps of:
a) entering a first information set comprising customer information of a customer and service provider information of one or more service providers into a computing device (1), said service provider having proficiency to perform a service operation on an article of the customer;
b) entering service data related to performing said service operation on the article into the computing device (1), said service data comprise a textual description of the article and a graphic representation of the article, said graphic representation comprises motion images of the article;
c) sending the first information set and the service data to a host computer (5) in communication with the computing device (1);
d) receiving the first information set and the service data from the computing device (1) into the host computer (5);
e) retrieving a second information set from a first database (16) residing in storage media (6) of the host computer (5) based on the first information set;
f) selecting a template from a second database (14) residing in the storage media (6) of the host computer (5) based on the first information set and the service data;
g) generating a marketing document in the host computer (5) by integrating a receiving address of at least one recipient of the marketing document and a content from the first and the second information set, the service data and a marketing message into the template, wherein said marketing document comprises the motion images of the article; and
h) delivering the marketing document to the receiving address of said recipient in an electronic format suitable for presenting said motion images of the article on an output device.

2. The method of claim 1 wherein the receiving address is selected from a street address, a postal box address, an e-mail address, a web address, an electronic file location, a phone number of a phone device that can receive and display electronic documents of the recipient, or a combination thereof.

3. The method of claim 1 wherein the delivering step is selected from mailing via a postal service, e-mailing, electronic file transferring, or a combination thereof.

4. The method of claim 1 wherein the recipient is the customer.

5. The method of claim 1 wherein the article is selected from an automotive vehicle, a farm vehicle, an air craft, a water vessel, a house, a house appliance, furniture, an electronics appliance, a tool, or a consumer goods.

6. (canceled)

7. The method of claim 1 wherein the first information set further comprises agency information of an agency of a financial responsibility policy that covers at least a portion of a cost of the service operation.

8. The method of claim 7 wherein the article is an automotive vehicle.

9. The method of claim 8 wherein the service provider is an automotive vehicle body shop.

10. The method of claim 8 wherein the agency is an automotive vehicle insurance agency.

11. The method of claim 8 wherein the marketing document is generated by the service provider on behalf of the agency.

12. The method of claim 1 further comprising the step of storing the marketing document in a third database (15).

13. The method of claim 1 further comprising the step of creating a new template and storing the new template in the second database (14).

14. The method of claim 1 further comprising the step of customizing the marketing document.

15. The method of claim 14 further comprising the step of storing the customized marketing document in the 3rd database (15).

16. A marketing method comprising the steps of:
a) entering a first information set comprising customer information of a customer and service provider information of one or more service providers into a computing device (1), said service provider having proficiency to perform a service operation on an article of the customer;
b) entering service data related to performing said service operation on the article into the computing device (1), said service data comprise a textual description of the article and a graphic representation of the article, said graphic representation comprises motion images of the article;
c) selecting a template from a second database (14) residing in storage media (3) of the computing device (1) based on the first information set and the service data;
d) generating a marketing document in the computing device (1) by integrating a receiving address of at least one recipient of the marketing document and a content from the first information set, the service data and a marketing message into the template, wherein said marketing document comprises the motion images of the article; and
e) delivering the marketing document to the receiving address of said recipient in an electronic format suitable for presenting said motion images of the article on an output device.

17. A marketing method comprising the steps of:
a) entering a first information set comprising customer information of a customer and service provider information of one or more service providers into a computing device (1), said service provider having proficiency to perform a service operation on an article of the customer;
b) entering service data related to performing said service operation on the article into the computing device (1), said service data comprise a textual description of the article and a graphic representation of the article, said graphic representation comprises motion images of the article;
c) retrieving a second information set from a first database (16) residing in the storage media (3) of the computing device (1) based on the first information set;
d) selecting a template from a second database (14) residing in storage media (3) of the computing device (1) based on the first information set and the service data;
e) generating a marketing document in the computing device (1) by integrating a receiving address of at least one recipient of the marketing document and a content from the first and the second information set, the service data and a marketing message into the template, wherein said marketing document comprises the motion images of the article; and
f) delivering the marketing document to the receiving address of said recipient in an electronic format suitable for presenting said motion images of the article on an output device.
